(19) United States
(12) Patent Application Publication
(10) Pub. No.: US 2019/0255569 A1
(43) Pub. Date: Aug. 22, 2019

(54) AN INFRASOUND GENERATOR FOR ENHANCING THE COMBUSTION OF SOLID FUELS

(71) Applicant: Mats Olsson, Lidingo (SE)

(72) Inventor: Mats Olsson, Lidingo (SE)

(21) Appl. No.: 16/345,712

(22) PCT Filed: Oct. 24, 2017
(86) PCT No.: PCT/SE2017/000041

§ 371 Date: Apr. 28, 2019

(30) Foreign Application Priority Data
Oct. 31, 2016 (SE) 1600303-0

(51) Int. Cl. B06B 1/10; F23C 99/00; F23B 30/00

(52) U.S. Cl. CPC B06B 1/10; F23C 99/003; F23B 2900/00005; B06B 2201/70; F23B 7/005

(57) ABSTRACT

The invention refers to an infrasound generator for enhancing the combustion of solid fuels burning in a combustion chamber. The infrasound is generated by one or more set(-s) of each two vibrating plates, vibrating in the same direction with the same displacement amplitude but in antiphase. The infrasound generator does not cause vibrations and is not sensitive to ash and heat from the combustion.

The present invention relates to an infrasound generator for enhancing the combustion of solid fuels.

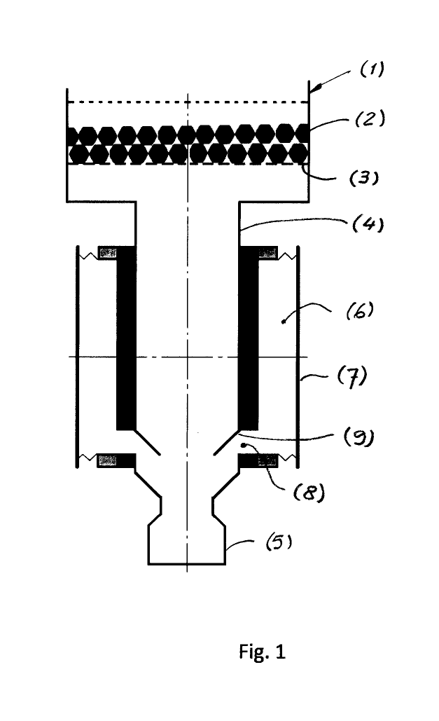

It is known from, among others, the patent SE 461 896 that infrasound can be used for enhancing combustion of solid fuels. FIG. 1 of said patent application shows that the infrasound generator may be attached to the down pipe below the support grate of the burning fuel.

There are, however, a couple of problems associated with that type of infrasound generators.

One problem is that the infrasound generates vibrations.

Another problem is that it is difficult to generate enough acoustic power.

A third problem is that it is a risk that soot and ash particles from the combustion process enters into the infrasound generator.

A fourth problem is that heat from the combustion process may be transferred from the combustion process to the infrasound generator, resulting in too high temperature of the infrasound generator.

The object of the present invention is to provide an infrasound generator that overcomes the problems mentioned above.

The infrasound generator of the present invention is characterized in that it comprises one or more set(-s) of identical, parallel vibrating plates moving in the same direction but in antiphase. These vibrating plates generate an infrasound, but they do not cause vibrations as they move in the same direction, with the same displacement amplitude but in antiphase.

Each vibrating plate is mounted at a sound chamber. The two sound chambers of one set are mounted opposite each other at the down pipe below the combustion chamber.

The combustion is enhanced by a direct infrasound, which means that the travelling distance of the infrasound from the vibration plates to the burning solid fuel is much less than the wavelength of the infrasound, preferably less than one eighth of the wavelength of the infrasound.

The present description is now to be explained more closely by means of embodiments, which are disclosed as examples, and with reference to attached drawings.

FIG. 1 is a cross sectional sketch of the infrasound generator and the combustion chamber.

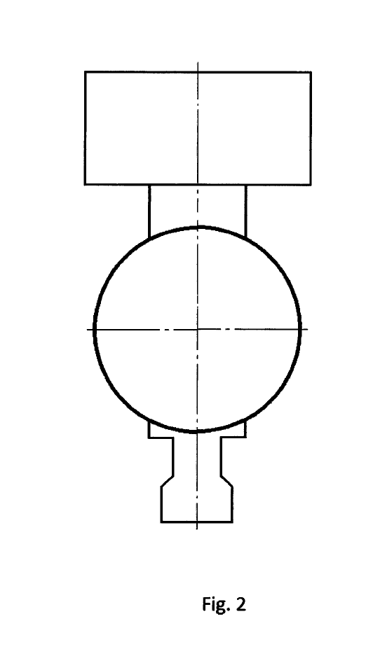

FIG. 2 is a side view of FIG. 1.

FIG. 1 shows a combustion chamber (1) containing solid fuel (2) supported by a grate (3).

A vertical down pipe (4) connects the combustion chamber (1) to the ash pot (5).

The figure also shows a set of two sound chambers (6) situated opposite each other at each side of the down pipe (4). Vibrating plates (7) are mounted at each of the sound chambers (6).

There are connections (8) for the flow of infrasound between the sound chambers (6) and the down pipe (4).

There are flaps (9) preventing ash from the combustion to enter the sound chambers (6) via the openings (8).

The benefits of this invention are:
The set(-s) of two plates (7) vibrating in the same direction with the same displacement amplitude but in antiphase does not cause vibrations.
It is possible to generate a high acoustic power due to the fact that the design includes two or more vibration plates (7).
The flaps (9) prevents ash particles from the combustion to enter into the sound cambers (6).
The connections (8) have no pockets that could be filled by ach particles.
There is a long distance from the burning solid fuel (2) to the vibrating plates (7) via the connections (8).

1. An infrasound generator for enhancing the combustion of solid fuels (2) burning in a combustion chamber (1), equipped with a vertical down pipe (4) characterized in that said infrasound generator comprises one or more set(-s) of each two vibrating plates (7), each of said vibrating plate (7) of said set, situated parallel to each other, vibrating in the same direction with the same displacement amplitude but in antiphase and that
each vibrating plate (7) is connected to a sound chamber (6) and that
said down pipe (4) is situated between said sound chambers (6) and that
there are connections (8) for the flow of infrasound between said sound chambers (6) and said down pipe (4).

2. An infrasound generator according to claim 1 characterized in that the connections (8) between said sound cambers (6) and said down pipe (4) have no pockets where ash particles can fill up.

3. An infrasound generator according to claim 1 characterized in that there are flaps (9) in front of the connections (8) preventing ash particles from the combustion to enter into the sound chambers (6).

4. An infrasound generator according to claim 1, characterized in that the frequency of the sound generated by said infrasound generator is between 7 to 19 Hz.

5. An infrasound generator according to claim 4 characterized in that the frequency of the sound generated by said infrasound generator is between 11 to 16 Hz.
